(19) United States
(12) Patent Application Publication
(10) Pub. No.: US 2016/0306340 A1
(43) Pub. Date: Oct. 20, 2016

(54) ROBOT AND CONTROL DEVICE

(71) Applicant: Seiko Epson Corporation, Tokyo (JP)

(72) Inventors: Takashi NAMMOTO, Azumino (JP); Kenichi MARUYAMA, Tatsuno (JP); Tomoki HARADA, Matsumoto (JP); Kazuhiro KOSUGE, Sendai (JP); Haruaki CHIBA, Tsuchiura (JP)

(21) Appl. No.: 15/099,874

(22) Filed: Apr. 15, 2016

(30) Foreign Application Priority Data
Apr. 17, 2015 (JP) 2015-084980

(51) Int. Cl. G05B 19/402; B25J 9/16

(52) U.S. Cl. CPC G05B 19/402; B25J 9/1612; G05B 2219/39478

(57) ABSTRACT

A robot includes an arm and a hand. The robot brings a tool gripped by the hand into contact with an object and changes at least one of the position and the posture of the hand gripping the tool.

### BACKGROUND

1. Technical Field

The present invention relates to a robot and a control device.

2. Related Art

Researches and developments of a robot that performs predetermined work have been performed.

In the relation, there has been known a technique for causing a robot including a dedicated end effector for performing specific work to perform the work (see WO2013/128542 (Patent Literature 1)).

However, in the related art, the robot has to include the dedicated end effector. It is difficult to improve versatility of the robot.

### SUMMARY

An aspect of the invention is directed to a robot including an arm and a hand. The robot brings a tool gripped by the hand into contact with an object and changes at least one of the position and the posture of the hand gripping the tool.

With this configuration, the robot brings the tool gripped by the hand into contact with the object and changes at least one of the position and the posture of the hand gripping the tool. Consequently, the robot can perform work without using a dedicated end effector. Therefore, it is possible to improve versatility of the robot.

In the robot according to the aspect of the invention, the robot may reduce a gripping force of the hand gripping the tool to make it possible to change at least one of the position and the posture.

With this configuration, the robot reduces the gripping force of the hand gripping the tool to make it possible to change at least one of the position and the posture of the hand gripping the tool. Consequently, the robot can change at least one of the position and the posture of the hand gripping the tool while the hand keeps the position and the posture of the tool fixed.

In the robot according to the aspect of the invention, the robot may change at least one of the position and the posture after work performed by the hand with the tool.

With this configuration, the robot changes at least one of the position and the posture after the work performed by the hand with the tool. Consequently, the robot can change, every time the work is performed, the position and the posture of the hand gripping the tool to a position and a posture suitable for the work.

In the robot according to the aspect of the invention, the object may be a jig on which the tool is placed.

In the robot according to the aspect of the invention, the object may be a part of a workbench.

In the robot according to the aspect of the invention, the object may be a part of the robot.

In the robot according to the aspect of the invention, the robot may change at least one of the position and the posture before the hand performs first work performed by the hand with the tool.

With this configuration, before the hand performs the first work performed by the hand with the tool, the robot changes at least one of the position and the posture of the hand gripping the tool. Consequently, the robot can start work in a state in which the position and the posture of the hand gripping the tool are changed to a position and a posture suitable for the work.

In the robot according to the aspect of the invention, the robot may change at least one of the position and the posture when at least one of the position and the posture deviates.

With this configuration, when at least one of the position and the posture of the hand gripping the tool deviates, the robot changes at least one of the position of the posture of the hand gripping the tool. Consequently, every time the position and the posture of the hand gripping the tool deviate, the robot can change the position and the posture of the hand gripping the tool to a position and a posture suitable for work.

In the robot according to the aspect of the invention, a plurality of the arms may be provided, and the hand may be provided in each of a part or all of the plurality of arms.

With this configuration, a part or all of the plurality of hands grip the tool. The robot brings the tool gripped by a part or all of the plurality of hands into contact with the object and changes at least one of the position and the posture of the tool gripped by a part or all of the plurality of hands.

In the robot according to the aspect of the invention, the hand may be detachably attachable to the arm.

Another aspect of the invention is directed to a control device that causes a robot including an arm and a hand to bring a tool gripped by the hand into contact with an object and change at least one of the position and the posture of the hand gripping the tool.

With this configuration, the control device causes the robot to bring the tool gripped by the hand into contact with the object and change at least one of the position and the posture of the hand gripping the tool. Consequently, the control device can cause the robot to perform work without using a dedicated end effector. Therefore, it is possible to improve versatility of the robot.

As explained above, the robot and the control device bring the tool gripped by the hand into contact with the object and change at least one of the position and the posture of the hand gripping the tool. Consequently, the robot and the control device can perform highly accurate work with the tool gripped by the hand.

### BRIEF DESCRIPTION OF THE DRAWINGS

The invention will be described with reference to the accompanying drawings, wherein like numbers reference like elements.

FIG. 1 is a configuration diagram showing an example of a robot according to an embodiment.

FIGS. 2A to 2C are diagrams showing an example of a jig.

FIGS. 3A and 3B are diagrams showing an example of a state in which an electric driver is placed on the jig.

FIG. 4 is a diagram showing an example of the hardware configuration of a control device.

FIG. 5 is a diagram showing the functional configuration of the control device.

FIG. 6 is a flowchart for explaining an example of a flow of processing in which a control section according to the embodiment causes the robot to perform first work to third work.

FIG. 7 is a flowchart for explaining an example of a flow of processing in which the control section causes a first arm to operate in step S120 shown in FIG. 6.

FIG. 8 is a flowchart for explaining an example of a flow of processing in which the control section causes a second arm to operate in step S120 shown in FIG. 6.

FIG. 9 is a flowchart for explaining an example of a flow of processing in which the control section causes the second arm to operate in step S130 shown in FIG. 6.

FIG. 10 is a flowchart for explaining an example of a flow of processing in which the control section causes the first arm to operate in step S150 shown in FIG. 6.

FIG. 11 is a flowchart for explaining an example of a flow of processing in which the control section causes the first arm to operate in step S150 shown in FIG. 6.

FIG. 12 is a flowchart for explaining an example of a flow of processing in which the control section according to a modification of the embodiment causes the second arm to operate in the second work.

### DESCRIPTION OF EXEMPLARY EMBODIMENTS

### Embodiment

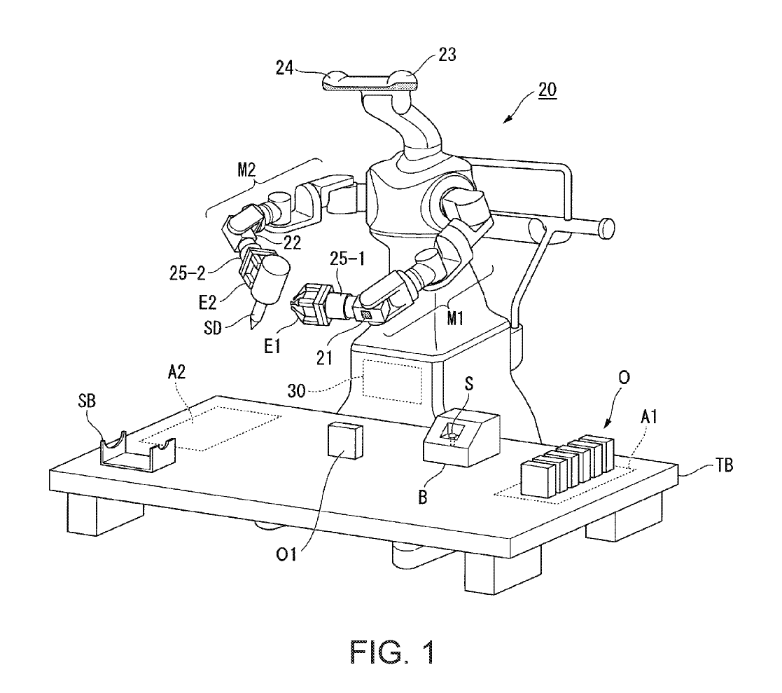

An embodiment of the invention is explained below with reference to the drawings. FIG. 1 is a configuration diagram showing an example of a robot 20 according to the embodiment. The robot 20 is a double arm robot including a first arm, a second arm, a first image pickup section 21, a second image pickup section 22, a third image pickup section 23, a fourth image pickup section 24, a first force sensor 25-1, a second force sensor 25-2, and a control device 30.

The double arm robot is a robot including two arms like the first arm and the second arm in this example. Note that the robot 20 may be a single arm robot instead of the double arm robot. The single arm robot is a robot including one arm. For example, the single arm robot includes one of the first arm and the second arm. The robot 20 may not include a part or all of the first image pickup section 21, the second image pickup section 22, the third image pickup section 23, and the fourth image pickup section 24.

The first arm is configured by a first end effector E1, a first manipulator M1, and a not-shown plurality of actuators. Note that the first end effector E1 may be detachably attachable to the first arm or may not be detachably attachable to the first arm. In the following explanation, the plurality of actuators included in the first arm are collectively referred to as first actuators. The first arm is an arm of a seven-axis vertical multi-joint type. Specifically, the first arm performs a motion of a degree of freedom of seven axes according to an associated motion of a supporting table, the first manipulator M1, and the first end effector E1 by the first actuators. Note that the first end effector E1 is an example of a hand.

When the first arm operates with the degree of freedom of seven axes, postures that the first arm can take increase compared with postures that the first arm can take when the first arm operates with a degree of freedom of six or fewer axes. Therefore, for example, the first arm operates smoothly. Further, the first arm can easily avoid interference with an object present around the first arm. When the first arm operates with the degree of freedom of seven axes, control of the first arm is easy compared with the control of the first arm operating with a degree of freedom of eight or more axes because computation complexity is less. Because of such reasons, in this example, the first arm desirably operates with the degree of freedom of seven axes. Note that the first arm may operate with the degree of freedom of six or fewer axes or may operate with the degree of freedom of eight or more axes.

The first actuators are communicably connected to the control device 30 by cables. Consequently, the first actuators can cause the first end effector E1 and the first manipulator M1 to operate on the basis of a control signal acquired from the control device 30. Note that wired communication via the cables is performed according to a standard such as an Ethernet (registered trademark) or a USB (Universal Serial bus). A part or all of the first actuators may be connected to the control device 30 by wireless communication performed according to a communication standard such as a Wi-Fi (registered trademark).

The first arm further includes the first image pickup section 21.

The first image pickup section 21 is, for example, a camera including a CCD (Charge Coupled Device) or a CMOS (Complementary Metal Oxide Semiconductor), which is an image pickup device that converts collected light into an electric signal. In this example, the first image pickup section 21 is provided in a part of the first manipulator M1 configuring the first arm as shown in FIG. 1. Therefore, the first image pickup section 21 is capable of moving according to a movement of the first arm. A range in which the first image pickup section 21 can perform image pickup changes according to the movement of the first arm. The first image pickup section 21 may pick up a still image in the range as a first image or may pick up a moving image in the range as the first image.

The first image pickup section 21 is communicably connected to the control device 30 by a cable. Wired communication via the cable is performed according to a standard such as the Ethernet (registered trademark) or the USB. Note that the first image pickup section 21 may be connected to the control device 30 by wireless communication performed according to a communication standard such as the Wi-Fi (registered trademark).

The second arm is configured by a second end effector E2, a second manipulator M2, and a not-shown plurality of actuators. Note that the second end effector E2 may be detachably attachable to the second arm or may not be detachably attachable to the second arm. In the following explanation, the plurality of actuators included in the second arm are collectively referred to as second actuators. The second arm is an arm of the seven-axis vertical multi-joint type. Specifically, the second arm performs a motion of the degree of freedom of seven axes according to an associated motion of the supporting table, the second manipulator M2, and the second end effector E2 by the second actuators. Note that the second end effector E2 is an example of a hand. Because of reasons same as the reasons why the first arm desirably operates with the degree of freedom of seven axes, the second arm desirably operates with the degree of freedom of seven axes. The second arm may operate with the degree of freedom of six or fewer axes or may move with the degree of freedom of eight or more axes.

The second actuators are communicably connected to the control device 30 by cables. Consequently, the second actuator can cause the second end effector E2 and the second manipulator M2 to operate on the basis of a control signal acquired from the control device 30. Note that wired communication via the cables is performed by a standard such as the Ethernet (registered trademark) or the USB (Universal Serial Bus). Note that a part or all of the second actuators may be connected to the control device 30 by wireless communication performed according to a communication standard such as the Wi-Fi (registered trademark).

The second arm further includes the second image pickup section 22.

The second image pickup section 22 is, for example, a camera including a CCD or a CMOS, which is an image pickup device that converts collected light into an electric signal. In this example, the second image pickup section 22 is provided in a part of the second manipulator M2 configuring the second arm as shown in FIG. 1. Therefore, the second image pickup section 22 is capable of moving according to a movement of the second arm. A range in which the second image pickup section 22 can perform image pickup changes according to the movement of the second arm. The second image pickup section 22 may pick up a still image in the range as a second image or may pick up a moving image in the range as the second image.

The second image pickup section 22 is communicably connected to the control device 30 by a cable. Wired communication via the cable is performed according to a standard such as the Ethernet (registered trademark) or the USB. Note that the second image pickup section 22 may be connected to the control device 30 by wireless communication performed according to a communication standard such as the Wi-Fi (registered trademark).

The third image pickup section 23 is, for example, a camera including a CCD or a CMOS, which is an image pickup device that converts collected light into an electric signal. The third image pickup section 23 is set in a position where the third image pickup section 23 can pick up an image in a range including a region where the robot 20 performs work with one or both of the first arm and the second arm. In the following explanation, for convenience of explanation, the range is referred to as image pickup range. Note that the third image pickup section 23 may pick up a still image in the image pickup range as a third image or may pick up a moving image in the image pickup range as the third image.

The third image pickup section 23 is communicably connected to the control device 30 by a cable. Wired communication via the cable is performed according to a standard such as the Ethernet (registered trademark) or the USB. Note that the third image pickup section 23 may be connected to the control device 30 by wireless communication performed according to a communication standard such as the Wi-Fi (registered trademark).

The fourth image pickup section 24 is, for example, a camera including a CCD or a CMOS, which is an image pickup device that converts collected light into an electric signal. The fourth image pickup section 24 is set in a position where the fourth image pickup section 24 can pick up a stereo image in the image pickup range in conjunction with the third image pickup section 23. Note that the fourth image pickup section 24 may pick up a still image in the image pickup range as a fourth image or may pick up a moving image in the image pickup range as the fourth image.

The fourth image pickup section 24 is communicably connected to the control device 30 by a cable. Wired communication via the cable is performed according to a standard such as the Ethernet (registered trademark) or the USB. Note that the fourth image pickup section 24 may be connected to the control device 30 by wireless communication performed according to a communication standard such as the Wi-Fi (registered trademark).

The first force sensor 25-1 is provided between the first end effector E1 and the first manipulator M1. The first force sensor 25-1 detects a value indicating the magnitude of a force or a moment acting on the first end effector E1. Note that the first force sensor 25-1 may be another sensor such as a torque sensor that detects a value indicating the magnitude of a force or a moment applied to the first end effector E1. The first force sensor 25-1 outputs first force sensor information to the control device 30 through communication. The first force sensor information is information including, as an output value of the first force sensor 25-1, the value indicating the magnitude of the force or the moment detected by the first force sensor 25-1. The output value of the first force sensor 25-1 is an example of an output value of a force sensor.

The first force sensor 25-1 is communicably connected to the control device 30 by a cable. Wired communication via the cable is performed according to a standard such as the Ethernet (registered trademark) or the USB. Note that the first force sensor 25-1 may be connected to the control device 30 by wireless communication performed according to a communication standard such as the Wi-Fi (registered trademark).

The second force sensor 25-2 is provided between the second end effector E2 and the second manipulator M2. The second force sensor 25-2 detects a force or a moment acting on the second end effector E2. Note that the second force sensor 25-2 may be another sensor such as a torque sensor that detects a force or a moment applied to the second end effector E2. The second force sensor 25-2 outputs second force sensor information to the control device 30 through communication. The second force sensor information is information including, as an output value of the second force sensor 25-2, the value indicating the magnitude of the force or the moment detected by the second force sensor 25-2. The output value of the second force sensor 25-2 is an example of an output value of a force sensor.

The second force sensor 25-2 is communicably connected to the control device 30 by a cable. Wired communication via the cable is performed according to a standard such as the Ethernet (registered trademark) or the USB. Note that the second force sensor 25-2 may be connected to the control device 30 by wireless communication performed according to a communication standard such as the Wi-Fi (registered trademark).

In the following explanation, the first force sensor 25-1 and the second force sensor 25-2 are collectively referred to as force sensors 25 unless it is necessary to distinguish the first force sensor 25-1 and the second force sensor 25-2. In the following explanation, the first force sensor information and the second force sensor information are collectively referred to as force sensor information unless it is necessary to distinguish the first force sensor information and the second force sensor information. One or both of the first force sensor information and the second force sensor information are used for control based on force sensor information of the robot 20 by the control device 30. The control based on the force sensor information indicates, for example, compliance control such as impedance control.

In this example, the functional sections included in the robot 20 explained above acquire control signals from the control device 30 incorporated in the robot 20 and perform operations based on the acquired control signals. Note that the robot 20 may be controlled by the control device 30 set on the outside rather than incorporating the control device 30.

The control device 30 transmits a control signal to the robot 20 to thereby cause the robot 20 to operate. The control device 30 causes the robot 20 to perform predetermined work. In this example, the predetermined work is work for assembling a predetermined component to a predetermined target object using a predetermined tool gripped by the robot 20 with one or both of the first end effector E1 and the second end effector E2.

In the following explanation, as an example, the predetermined tool is an electric driver SD, the predetermined target object is a member O configuring apart of an industrial machine, and the predetermined component is a screw S. In FIG. 1, the member O is shown as an object having a rectangular parallelepiped shape. However, the shape of the member O is not limited to the rectangular parallelepiped shape and may be other shapes. In the following explanation, the robot 20 grips the electric driver SD with the second end effector E2. That is, in the predetermined work, the robot 20 fastens the screw S to the member O with the electric driver SD gripped by the second end effector E2.

Note that, in the following explanation, the roles of the first arm and the second arm may be reversed. The predetermined tool may be another tool used for some work such as a pen, a wrench, or a spray instead of the electric driver SD. The predetermined component may be another component corresponding to the predetermined tool instead of the screw S. For example, when the predetermined tool is the wrench, the predetermined component is a bolt or a nut.

The predetermined work performed by the robot 20 is explained with reference to FIG. 1. In FIG. 1, the robot 20 is gripping the electric driver SD with the second end effector E2. In this example, the distal end of the electric driver SD is magnetized. The distal end of the electric driver SD is a distal end of a shaft of the electric driver SD on the opposite side of a grip side of the electric driver SD. The electric driver SD can attract the screw S with the magnetism.

In this example, the electric driver SD has a shape symmetrical with respect to rotation around a rotation axis at the time when the shaft of the electric driver SD rotates. Therefore, the posture of the electric driver SD is represented by the direction of the rotation axis at the time when the shaft of the electric driver SD rotates. In the grip of the electric driver SD, for example, a switch is provided in a position where a metal washer is provided. When the switch is turned on, the electric driver SD rotates the shaft. Consequently, the electric driver SD can fasten the screw S to another object according to the rotation of the shaft.

In FIG. 1, a workbench TB includes a first region A1 where one or more members O before the fastening of the screw S are disposed and a second region A2 where one or more members O after the fastening of the screw S are disposed. A screw supply device B, a jig SB, and a work target O1 are placed on the workbench TB.

The first region A1 is a region where another robot, an operator who supplies the member O, or the like disposes (supplies) the member O for the predetermined work by the robot 20. The second region A2 is a region where the robot 20 disposes (removes) the member O after the fastening of the screw S. Note that the first region A1 and the second region A2 do not overlap each other. However, a part of the first region A1 and a part of the second region A2 may overlap each other.

The workbench TB is, for example, a table. Note that, instead of the table, the workbench TB may be another member such as a floor surface having a surface on which the screw supply device B, the jig SB, and the work target O1 can be placed. The workbench TB may be configured by a plurality of workbenches.

The screw supply device B supplies the screw S to a predetermined part. The robot 20 fits the distal end of the electric driver SD in the screw head of the screw S supplied to a predetermined part of the screw supply device B and attracts the screw S to the distal end of the electric driver SD with magnetism. The robot 20 moves the electric driver SD while keeping a state in which the screw S is attracted to the distal end of the electric driver SD. Consequently, the robot 20 removes the screw S from the predetermined part of the screw supply device B. When the screw S is removed from the predetermined part, the screw supply device B supplies the screw S to the part again.

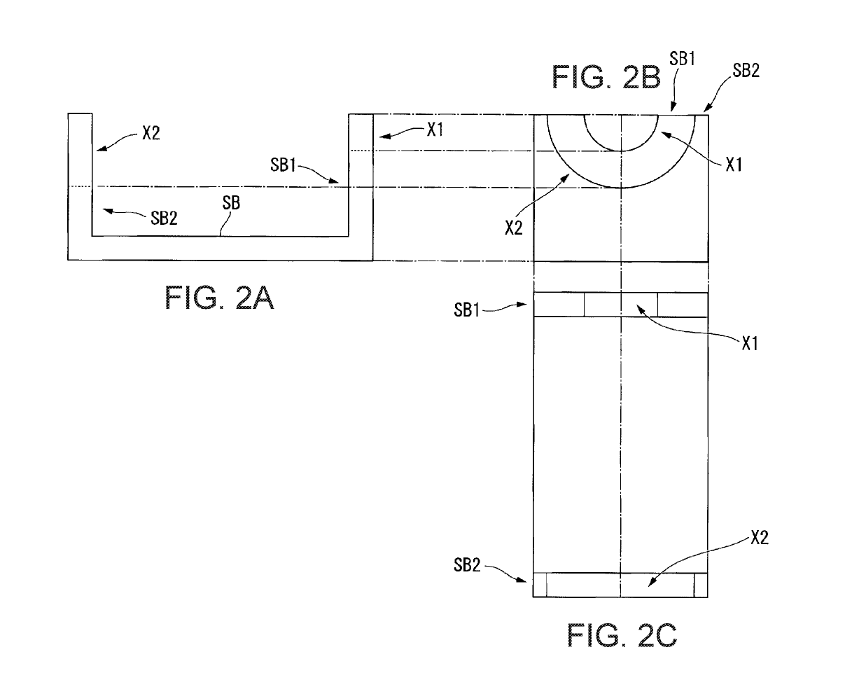

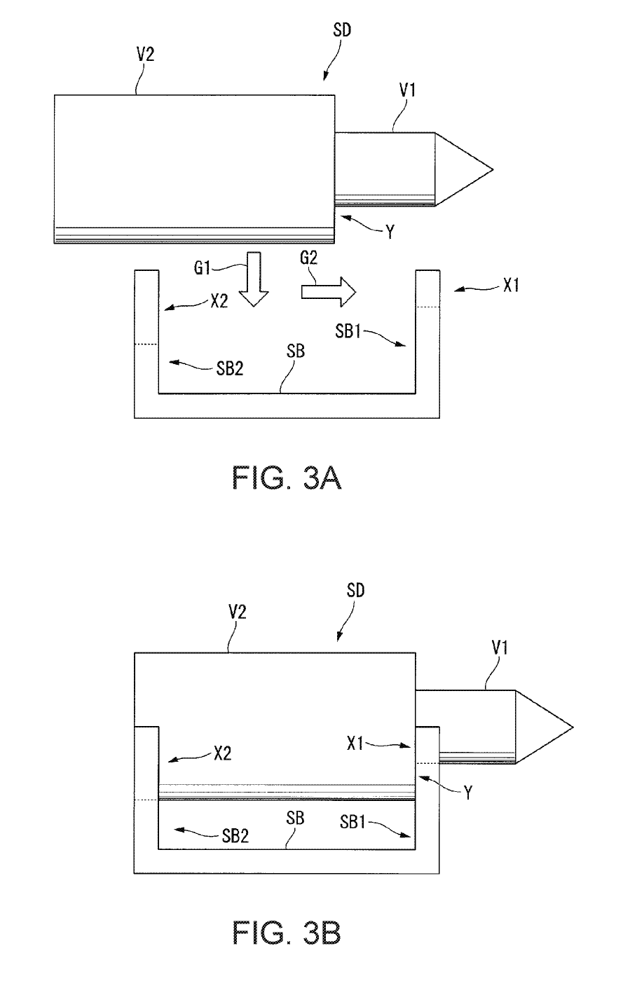

The jig SB is a jig on which the electric driver SD is placed. The jig SB is explained with reference to FIGS. 2A to 3B. FIGS. 2A to 2C are diagrams showing an example of the jig SB. A front view of the jig SB is shown in FIG. 2A. A side view of the jig SB is shown in FIG. 2B. A top view of the jig SB is shown in FIG. 2C.

As shown in FIGS. 2A to 2C, the jig SB includes a first part SB1 and a second part SB2. The first part SB1 is a tabular part vertically extending from the bottom surface of the jig SB. In the first part SB1, a cutout section X1 on which the shaft of the electric driver SD is placed is provided. In this example, the cutout section X1 is provided at an end portion of the first part SB1 on the upper surface side of the jig SB. The shape of the cutout section X1 in front view of the jig SB is a fan shape having a center angle of 180 degrees.

The second part SB2 is a tabular part vertically extending from the bottom surface of the jig SB and is a part on the opposite side of the first part SB1. In the second part SB2, a cutout section X2 on which the grip of the electric driver SD is placed is provided. In this example, the cutout section X2 is provided at an end portion of the second part SB2 on the upper surface side of the jig SB. The shape of the cutout section X2 in front view of the jig SB is a fan shape having a center angle of 180 degrees. Note that, in this example, the radius of the shaft of the electric driver SD is smaller than the radius of the grip of the electric driver SD. Therefore, the radius of the fan-shaped cutout section X1 is smaller than the radius of the fan-shaped cutout section X2.

As shown in FIGS. 3A and 3B, the electric driver SD is placed on the jig SB shown in FIGS. 2A to 2C. FIGS. 3A and 3B are diagrams showing an example of a state in which the electric driver SD is placed on the jig SB. In FIG. 3A, an example of a state of the electric driver SD and the jig SB before the electric driver SD is placed on the jig SB is shown. As shown in FIG. 3A, a shaft V1 of the electric driver SD has a radius smaller than the radius of a grip V2 of the electric driver SD. Therefore, the electric driver SD has a step Y in the boundary between the shaft V1 and the grip V2 when the electric driver SD is viewed from a direction (a side surface side) orthogonal to a rotation axis at the time when the shaft V1 of the electric driver SD rotates.

For example, the robot 20 moves the electric driver SD in a direction G1 shown in FIG. 3A with the second end effector E2. Consequently, the robot 20 brings the shaft V1 of the electric driver SD into contact with the cutout section X1 and brings the grip V2 of the electric driver SD into contact with the cutout section X2. Thereafter, the robot 20 moves the electric driver SD in a direction G2 shown in FIG. 3A with the second end effector E2. Consequently, the robot 20 can bring the step Y into contact with the first part SB1. Note that the direction G1 indicates a direction orthogonal to the bottom surface of the jig SB and extending toward the bottom surface. The direction G2 indicates a direction extending along the bottom surface of the jig SB and in which the step Y comes into contact with the first part SB1.

The electric driver SD is placed on the jig SB in this way. In FIG. 3B, an example of a state of the electric driver SD and the jig SB after the electric driver SD is placed on the jig SB is shown. In FIG. 1, the jig SB is fixed to the workbench TB. Therefore, the position and the posture of the jig SB are fixed. The position and the posture of the jig SB indicate the position and the posture of a predetermined part of the jig SB. The predetermined part of the jig SB is, for example, the center of gravity of the jig SB. Note that, instead, the predetermined part of the jig SB may be another part of the jig SB.

Since the position and the posture of the jig SB are fixed, the position and the posture of the electric driver SD are in a predetermined placing position and a predetermined placing posture when the electric driver SD is placed on the jig SB. The position of the electric driver SD is the position of a predetermined part of the electric driver SD. The predetermined part of the electric driver SD is, for example, the center of gravity of the electric driver SD. Note that, instead, the predetermined part of the electric driver SD may be another part.

The predetermined placing position is a position determined as a position in a robot coordinate system coinciding with the predetermined part of the electric driver SD in a state in which the electric driver SD is placed on the jig SB. The predetermined placing posture refers to a direction in which the rotation axis at the time when the shaft of the electric driver SD rotates faces in the state in which the electric driver SD is placed on the jig SB.

That is, since the jig SB is fixed to the workbench TB, when the electric driver SD is placed on the jig SB, the position of the electric driver SD is fixed in the predetermined placing position. Since the jig SB is fixed to the workbench TB, when the electric driver SD is placed on the jig SB, the posture of the electric driver SD is fixed in the predetermined placing posture.

Making use of the above, in fastening the screw S to the member O in the predetermined work, even when the relative position and the relative posture of the predetermined part of the second end effector E2 with respect to the position and the posture of the electric driver SD gripped by the second end effector E2 deviate, the robot 20 can change the position and the posture. As a result, the robot 20 can change (keep) the relative position and the relative posture of the predetermined part of the second end effector E2 with respect to the position and the posture of the electric driver SD gripped by the second end effector E2 to (in) a position and a posture suitable for the predetermined work. Note that the position and the posture suitable for the predetermined work are determined in advance.

Note that, in the following explanation, for convenience of explanation, an operation of the robot 20 for changing the relative position and the relative posture of the predetermined part of the second end effector E2 with respect to the position and the posture of the electric driver SD gripped by the second end effector E2 to the position and the posture suitable for the predetermined work is referred to as posture changing operation.

In this example, the robot 20 performs the predetermined work by performing first work, second work, and third work in order. In the first work, the robot 20 supplies, with the first end effector E1, the member O from the first region A1 where the member O is disposed, grips, with the second end effector E2, the electric driver SD from the jig SB on which the electric driver SD is placed, and supplies the screw S with the electric driver SD gripped by the second end effector E2. Such first work is preparation for performing the second work.

In the second work, the robot 20 fastens, with the electric driver SD gripped by the second end effector E2, the screw S to the member O fixed by the first end effector E1. In the second work, the robot 20 performs a posture changing operation every time the robot 20 fastens the screw S to the member O. Consequently, the robot 20 can continue to perform highly accurate work. In the third work, the robot 20 disposes, in the second region A2 where the member O to which the screw S is fastened is disposed, with the first end effector E1, the member O to which the screw S is fastened and places the electric driver SD on the jig SB with the second end effector E2. That is, the third work is clean-up after the second work.

In this way, the robot 20 brings the electric driver SD gripped by the second end effector E2 into contact with a predetermined object and changes at least one of the position and the posture of the second end effector E2 gripping the electric driver SD. In this example, the predetermined object refers to the first part SB1 of the jig SB.

The position of the second end effector E2 is represented by degrees of translation freedom (i.e., three coordinates) in respective directions of three axes in the robot coordinate system of the second end effector E2. The posture of the second end effector E2 is represented by degrees of rotation freedom (i.e., three rotation angles) around respective axes of the three axes in the robot coordinate system of the second end effector E2. That is, the position and the posture of the second end effector E2 are represented by six degrees of freedom including the degrees of translation freedom and the degrees of rotation freedom. Changing the position and the posture of the second end effector E2 indicates that at least one of the six degrees of freedom is changed. Note that explanation of the position and the posture of the first end effector E1 is omitted because the position and the posture are the same as the position and the posture of the second end effector E2.

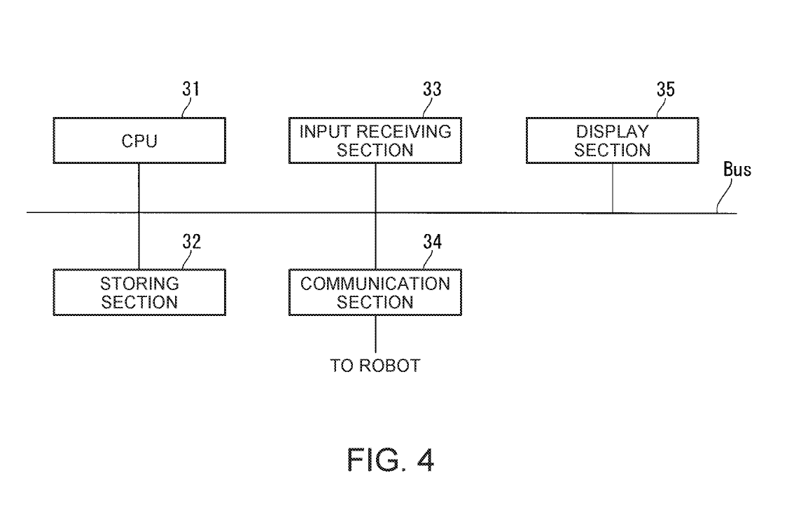

The hardware configuration of the control device 30 is explained with reference to FIG. 4. FIG. 4 is a diagram showing an example of the hardware configuration of the control device 30. The control device 30 includes, for example, a CPU (Central Processing Unit) 31, a storing section 32, an input receiving section 33, a communication section 34, and a display section 35. The control device 30 performs communication with the robot 20 via the communication section 34. These components are communicably connected to one another via a bus Bus.

The CPU 31 executes various computer programs stored in the storing section 32.

The storing section 32 includes, for example, an HDD (Hard Disk Drive), an SSD (Solid State Drive), an EEPROM (Electrically Erasable Programmable Read-Only Memory), a ROM (Read-Only Memory), or a RAM (Random Access Memory). The storing section 32 stores various kinds of information, images, and computer programs to be processed by the control device 30. Note that the storing section 32 may be an external storage device connected by, for example, a digital input/output port of the USB or the like instead of a storage device incorporated in the control device 30.

The input receiving section 33 is, for example, a keyboard, a mouse, a teaching pendant including a touch pad, or another input device. Note that the input receiving section 33 may be configured integrally with the display section 35 as a touch panel.

The communication section 34 includes, for example, a digital input/output port such as a USB or an Ethernet (registered trademark) port.

The display section 35 is, for example, a liquid crystal display panel or an organic EL (Electroluminescence) display panel.

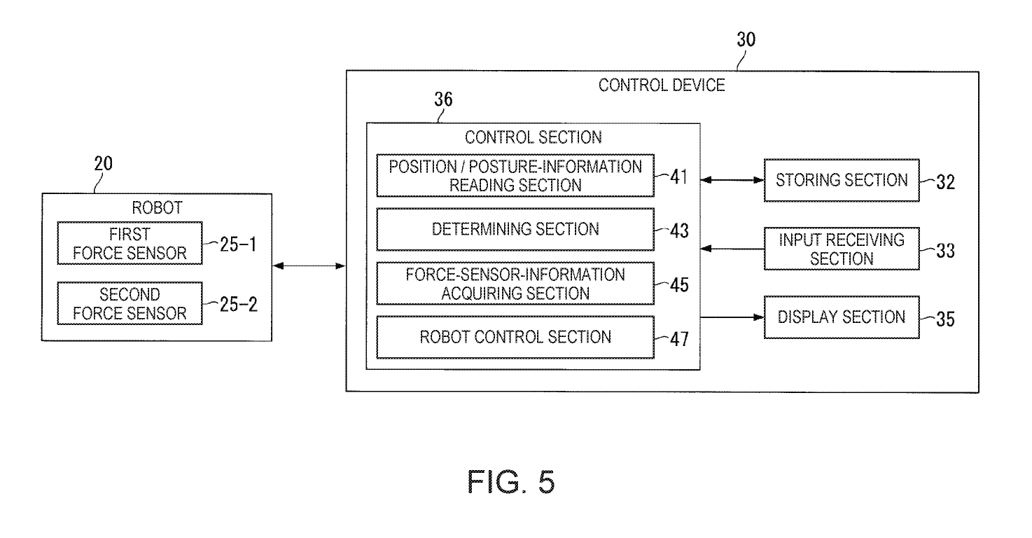

The functional configuration of the control device 30 is explained with reference to FIG. 5. FIG. 5 is a diagram showing an example of the functional configuration of the control device 30. The control device 30 includes the storing section 32, the input receiving section 33, the display section 35, and a control section 36.

The control section 36 controls the entire control device 30. The control section 36 includes a position/posture-information reading section 41, a determining section 43, a force-sensor-information acquiring section 45, and a robot control section 47. A part or all of these functional sections included in the control section 36 are realized by, for example, the CPU 31 executing the various computer programs stored in the storing section 32. A part or all of the functional sections may be hardware functional sections such as an LSI (Large Scale Integration) and an ASIC (Application Specific Integrated Circuit).

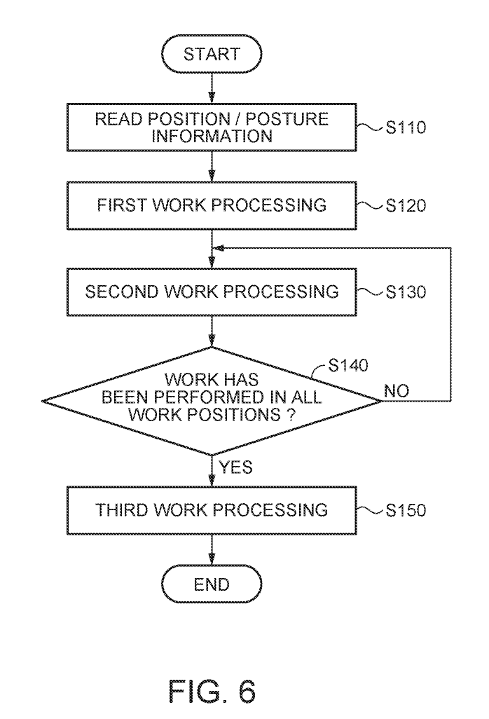

The position/posture information reading section 41 reads information indicating various positions and postures from the storing section 32. The various positions and postures indicate a plurality of positions and a plurality of postures necessary for the robot 20 to perform the predetermined work. In a flowchart shown in FIG. 6, an example of the information indicating the plurality of positions and the plurality of postures is explained.

The determining section 43 determines whether the robot 20 fastens the screw S in all work positions. The work positions indicate a plurality of positions determined in advance to fasten the screw S to the member O.

The force-sensor-information acquiring section 45 acquires force sensor information detected by the force sensors 25.

The robot control section 47 causes the robot 20 to operate on the basis of the information indicating the various positions and postures read by the position/posture-information reading section 41. The robot control section 47 causes the robot 20 to perform the first work to the third work to thereby perform the predetermined work.

Processing in which the control section 36 according to this embodiment causes the robot 20 to perform the first work to the third work is explained with reference to FIG. 6. FIG. 6 is a flowchart for explaining a flow of processing in which the control section 36 according to this embodiment causes the robot 20 to perform the first work to the third work. In the following explanation, as an example, only one member O is disposed in the first region A1. That is, the control section 36 causes the robot 20 to perform the predetermined work on the member O. When a plurality of members O are disposed in the first region A1, the control section 36 executes the processing shown in FIG. 6 on the respective members O to thereby cause the robot 20 to perform the predetermined work.

First, the position/posture-information reading section 41 reads the information indicating the various positions and postures from the storing section 32 (step S110). In this example, the position/posture-information reading section 41 reads member-supply-position/posture information, member-removal-position/posture information, and fixed-position/posture information as the information indicating the various positions and postures. The member-supply-position/posture information indicates a position and a posture in the robot coordinate system of the member O disposed in the first region A1. The position and the posture of the member O indicate the position and the posture of a predetermined part of the member O. The predetermined part of the member O is, for example, the center of gravity of the member O. Note that the predetermined part of the member O may be another part of the member O.

The member-removal-position/posture information indicates a position and a posture in the robot coordinate system with which the robot 20 matches the position and the posture of the member O when the robot 20 removes the member to the second region A2. The fixed-position/posture information indicates a position and a posture in the robot coordinate system with which the robot 20 matches the position and the posture of the member O when the robot 20 fixes the member O in the predetermined work. Note that, in step S110, the position/posture-information reading section 41 may read, as the information indicating the various positions and postures, a part of the information, may read information indicating other positions and postures in addition to the information, or may read information indicating other positions and postures separately from these kinds of information.

Subsequently, the robot control section 47 causes the robot 20 to perform the first work on the basis of the member-supply-position/posture information read by the position/posture-information reading section 41 in step S110 (step S120). The robot control section 47 causes the robot 20 to perform the second work (step S130). The determining section 43 determines whether the robot 20 has fastened the screw S in all work positions determined in advance in the member O to which the screw S is fastened in the second work (step S140).

When the determining section 43 determines that the robot 20 has not fastened the screw S in all the work positions (No in step S140), the robot control section 47 transitions to step S130 and causes the robot 20 to perform the second work again. On the other hand, when the determining section 43 determines that the robot 20 has fastened the screw S in all the work positions (Yes in step S140), the robot control section 47 causes the robot 20 to perform the third work (step S150).

Note that, in this example, the robot control section 47 causes, for each of the first work to the third work, one or both of the first end effector E1 and the second end effector E2 to operate. That is, the robot control section 47 does not cause one or both of the first end effector E1 and the second end effector E2 to operate across the first work and the second work or across the second work and the third work.

Note that the robot control section 47 may cause one or both of the first end effector E1 and the second end effector E2 to operate across the first work and the second work or across the second work and the third work. When the same operation is performed in the next work continuously from certain work, for example, the last operation of the first end effector E1 in certain work is standby and the operation of the first end effector E1 in the next work is standby, the robot control section 47 causes the first end effector E1 to operate across the certain work and the next work. This holds true concerning the second end effector E2.

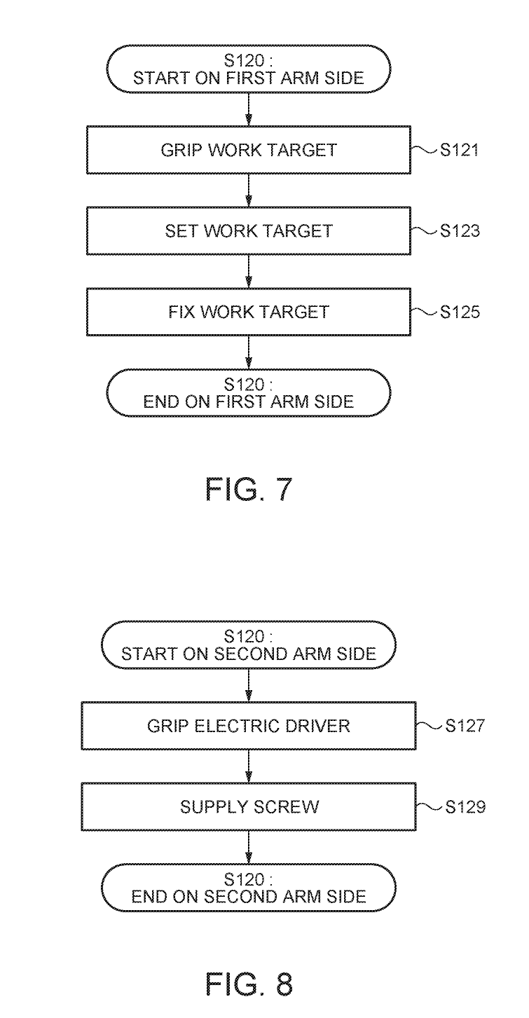

Processing in which the control section 36 causes the first arm and the second arm to perform an operation related to the first work in step S120 shown in FIG. 6 is explained with reference to FIGS. 7 and 8. In step S120, the control section 36 causes both of the first arm and the second arm to operate in parallel. Note that, instead of this, the control section 36 may cause the first arm and the second arm to operate in order in step S120.

FIG. 7 is a flowchart for explaining a flow of processing in which the control section 36 causes the first arm to operate in step S120 shown in FIG. 6.

First, the robot control section 47 reads member information indicating the shape and the size of the member O stored in advance. The robot control section 47 causes, on the basis of the read member information and the member-supply-position/posture information read by the position/posture-information reading section 41 in step S110 shown in FIG. 6, the first end effector E1 to grip the member O disposed in the first region A1 (step S121).

Subsequently, the robot control section 47 causes, on the basis of the fixed-position/posture information read by the position/posture-information reading section 41 in step S110 shown in FIG. 6, the first end effector E1 to move the member O such that the position and the posture of the member O coincide with the position and the posture in the robot coordinate system indicated by the fixed-position/posture information (step S123). Subsequently, the robot control section 47 causes the first end effector E1 to fix the member O such that the position and the posture of the member O after the first end effector E1 moves the member O in step S123 do not change (step S125).

More specifically, the robot control section 47 causes the first end effector E1 to fix the member O such that the position and the posture of the member O do not deviate because of screw fastening by the electric driver SD in the predetermined work. “The position and the posture of the member O deviate” indicates that, for example, the member O rotates together with the shaft of the electric driver SD when screw fastening is performed by the electric driver SD or the member O is translated by vibration due to rotation of the shaft of the electric driver SD.

The robot control section 47 fixes the member O to the first end effector E1 not to cause such translation or rotation. For example, the robot control section 47 brings claw sections included in the first end effector E1 into contact with respective two surfaces configuring corners of the member O to thereby fix the member O. In the following explanation, for convenience of explanation, a position and a posture in the robot coordinate system of the member O at the time when the first end effector E1 fixes the member O in step S125 are referred to as fixed position and posture.

In this way, according to the processing in steps S121 to S125, the robot control section 47 fixes the position and the posture of the member O to the fixed posit ion and posture. Note that, when the operation of the second arm in the first work does not end at a stage when the processing in step S125 ends, the robot control section 47 puts the first arm on standby until the operation ends.

FIG. 8 is a flowchart for explaining an example of a flow of processing in which the control section 36 causes the second arm to operate in step S120 shown in FIG. 6.

First, the robot control section 47 reads information stored in advance, that is, tool-placing-position/posture information indicating a position and a posture in the robot coordinate system of the electric driver SD in a state in which the electric driver SD is placed on the jig SB. The robot control section 47 reads tool information indicating the shape and the size of the electric driver SD stored in advance. The robot control section 47 causes, on the basis of the read tool-placing-position/posture information and the read tool information, the second end effector E2 to grip the electric driver SD placed on the jig SB (step S127).

Subsequently, the robot control section 47 fits, on the basis of information indicating a position in the robot coordinate system of the screw head of the screw S supplied to the predetermined part of the screw supply device B stored in advance and the tool information read in step S127, the screw head in the distal end of the electric driver SD. In this case, the screw S is attracted to the distal end of the electric driver SD by magnetism. The robot control section 47 moves the electric driver SD to which the screw S is attracted and supplies the screw S from the screw supply device B (step S129).

In this way, according to the processing in steps S127 to S129, the robot control section 47 supplies the screw S from the screw supply device B to the distal end of the electric driver SD. Note that, when the operation of the first arm in the first work does not end at a stage when the processing in step S129 ends, the robot control section 47 puts the second arm on standby until the operation ends.

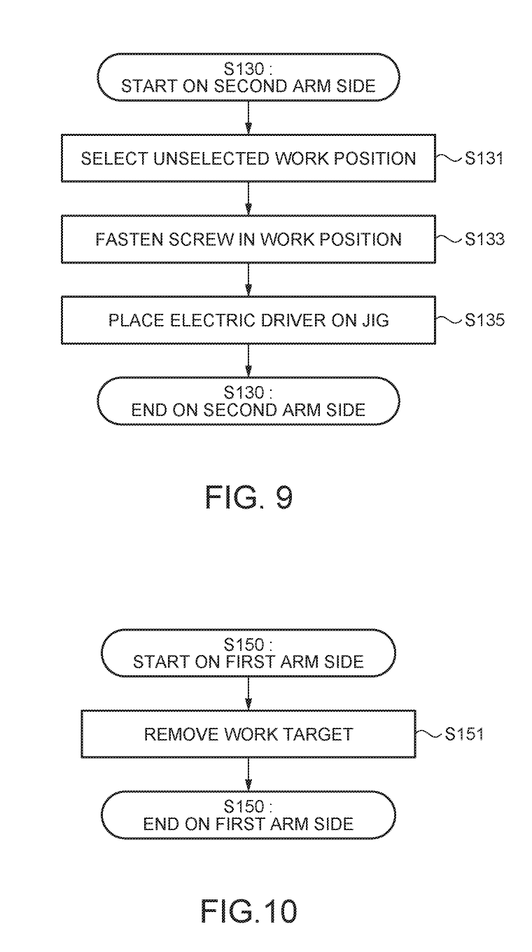

Processing in which the control section 36 causes the second arm to perform an operation related to the second work in step S130 shown in FIG. 6 is explained with reference to FIG. 9. The control section 36 causes only the second arm to operate in step S130. Note that, instead, the control section 36 may cause both of the first arm and the second arm to operate in step S130.

FIG. 9 is a flowchart showing an example of a flow of the processing in which the control section 36 causes the second arm to operate in step S130 shown in FIG. 6.

First, the robot control section 47 reads information indicating a respective plurality of work positions stored in advance. The robot control section 47 selects, on the basis of the read information indicating the work positions, one piece of information indicating an unselected work position (step S131).

Subsequently, the robot control section 47 moves the second end effector E2 on the basis of the information indicating the work position selected in step S131 and the tool information read in step S127 and inserts the distal end on the opposite side of the screw head of the screw S attracted to the distal end of the electric driver SD into the work position. The robot control section 47 causes the second end effector E2 to turn on a switch of the electric driver SD to thereby fasten the screw S in the work position into which the screw S is inserted (step S133). Note that, on the basis of the second force sensor information acquired by the force-sensor-information acquiring section 45, for example, when a moment applied to the second end effector E2 exceeds a predetermined value, the robot control section 47 determines that the screw S is fastened in the work position and causes the second end effector E2 to turn off the switch of the electric driver SD.

Subsequently, the robot control section 47 reads information indicating a position and a posture in the robot coordinate system of the jig SB stored in advance. The robot control section 47 places the electric driver SD on the jig SB on the basis of the read position and posture in the robot coordinate system of the jig SB and the tool-placing-position/posture information read in step S127.

In this case, the robot control section 47 moves the electric driver SD to the second end effector E2 such that a relative position and a relative posture of the electric driver SD with respect to the position and the posture of the jig SB are in a predetermined position and a predetermined posture. The predetermined position and the predetermined posture are, for example, as shown in FIG. 3A, a position and a posture where the electric driver SD is moved by a predetermined distance in a direction G1 with respect to the jig SB, whereby the shaft V1 comes into contact with the cutout section X1 and the grip V2 comes into contact with the cutout section X2 but the step Y does not come into contact with the first part SB1. The predetermined distance is, for example, approximately several centimeters. Note that, instead, the predetermined distance may be another distance.

After setting the position and the posture of the electric driver SD in the predetermined position and the predetermined posture with respect to the position and the posture of the jig SB, as shown in FIG. 3A, the robot control section 47 moves the electric driver SD in the direction G2 with respect to the jig SB. The robot control section 47 acquires second force sensor information from the force-sensor-information acquiring section 45. The robot control section 47 causes the second end effector E2 to operate according to control based on the acquired second force sensor information, moves the electric driver SD in the direction G2 with respect to the jig SB, and brings the step Y of the electric driver SD into contact with the first part SB1 of the jig SB.

Consequently, the robot control section 47 places the electric driver SD on the jig SB without causing the second end effector E2 to deform the jig SB (step S135). Note that, while the second arm fastens the screw S to the member O according to the processing in steps S131 to S135, the first arm stays on standby while keeping the member O fixed.

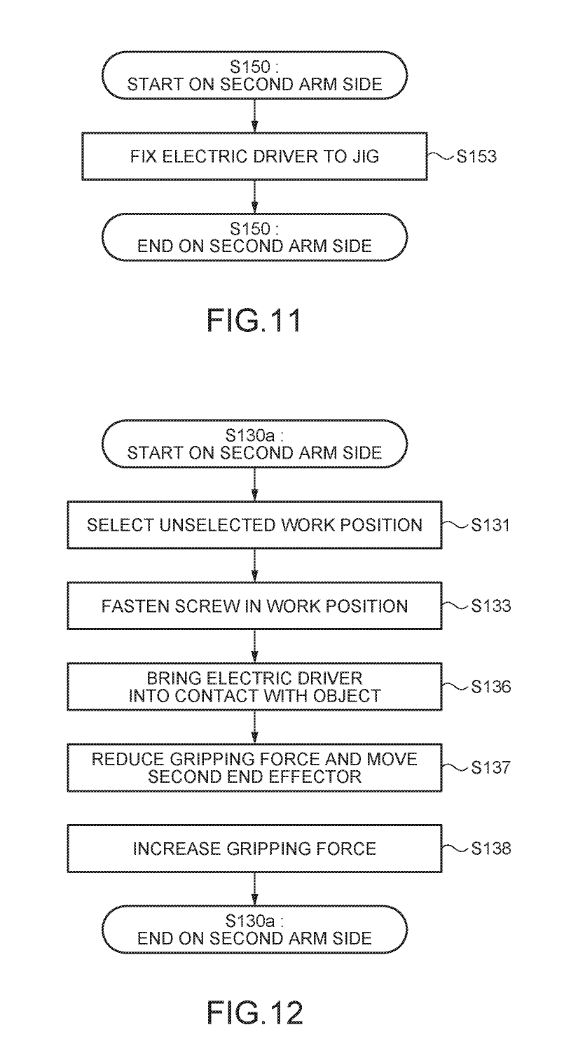

Processing in which the control section 36 causes the first arm and the second arm to perform an operation related to the third work in step S150 shown in FIG. 6 is explained with reference to FIGS. 10 and 11. In step S150, the control section 36 causes both of the first arm and the second arm to operate in parallel. Note that, instead, the control section 36 may cause the first arm and the second arm to operate in order in step S150.

FIG. 10 is a flowchart for explaining an example of a flow of the processing in which the control section 36 causes the first arm to operate in step S150 shown in FIG. 6.

First, the robot control section 47 causes the first end effector E1 to grip the member O fixed by the first end effector E1. The robot control section 47 causes, on the basis of the member-removal-position/posture information read by the position/posture-information reading section 41 in step S110 shown in FIG. 6, the first end effector E1 to move the member O such that the position and the posture of the member O coincide with the position and the posture in the robot coordinate system indicated by the member-removal-position/posture information (step S151). Note that, when the operation of the second arm in the third work does not end at a stage when the processing in step S151 ends, the robot control section 47 puts the first arm on standby until the operation ends.

FIG. 11 is a flowchart for explaining an example of the flow of the processing in which the control section 36 causes the first arm to operate in step S150 shown in FIG. 6.

First, the robot control section 47 fixes the electric driver SD to the jig SB with the second end effector E2 (step S153). In this example, the robot control section 47 already causes the second end effector E2 to place the electric driver SD on the jig SB in step S135 shown in FIG. 9. Therefore, the robot control section 47 does not have to do anything in step S153. When not performing the processing in step S135, in step S153, the robot control section 47 performs processing same as the processing in step S135 and causes the second end effector E2 to place the electric driver SD on the jig SB. An example in which the processing in step S135 is not performed is explained in a modification of the embodiment.

For example, when a mechanism for preventing the electric driver SD from being detached is provided in the jig SB, the robot control section 47 may cause the second end effector E2 to operate the mechanism and may fix the electric driver SD placed on the jig SB in step S135 not to be detached from the jig SB. In this case, it is assumed that processing for causing the second end effector E2 to operate the mechanism is taught to the robot control section 47 in advance. Note that, when the operation of the first arm in the third work does not end at a stage when the processing in step S153 ends, the robot control section 47 puts the first arm on standby until the operation ends.

As explained above, the robot 20 in this embodiment brings the electric driver SD gripped by the second end effector E2 into contact with the object and changes at least one of the position and the posture of the second end effector E2 gripping the electric driver SD. Consequently, the robot 20 can perform highly accurate work with the electric driver SD gripped by the second end effector E2 while securing versatility of the robot.

The robot 20 changes at least one of the position and the posture of the second end effector E2 gripping the electric driver SD after work performed by the second end effector E2 with the electric driver SD, for example, between the first work and the second work and between the second work and the third work. Consequently, the robot 20 corrects, every time work is performed, the position and the posture of the second end effector E2 gripping the electric driver SD to a position and a posture suitable for the work.

The robot 20 brings the electric driver SD gripped by the second end effector E2 into contact with the first part SB1 of the jig SB and changes at least one of the position and the posture of the second end effector E2 gripping the electric driver SD. Consequently, the robot 20 can perform highly accurate work with the electric driver SD gripped by the second end effector E2 using the jig SB.

### Modification of the Embodiment

A modification of the embodiment of the invention is explained below. In the robot 20 according to the modification of this embodiment, instead of placing the electric driver SD on (that is, bringing the electric driver SD into contact with) the jig SB to thereby change at least one of the position and the posture of the second end effector E2 gripping the electric driver SD, the robot 20 brings the distal end of the electric driver SD into contact with the workbench TB to thereby change at least one of the position and the posture of the second end effector E2 gripping the electric driver SD.

In this example, as the processing in step S130 shown in FIG. 6, instead of executing the processing of the flowchart shown in FIG. 9, the robot control section 47 executes processing in step S130a shown in FIG. 12. FIG. 12 is a flowchart for explaining a flow of processing in which the control section 36 according to the modification of this embodiment causes the second arm to operate in the second work. Note that explanation of processing in steps S131 and S133 shown in FIG. 12 is omitted because the processing is the same as the processing in steps S131 and S133 shown in FIG. 9.

After the processing in step S133 shown in FIG. 12, the robot control section 47 causes the second end effector E2 to operate and brings the distal end of the electric driver SD into contact with another object (step S136). In this example, the object is the workbench TB. More specifically, the robot control section 47 brings the distal end of the electric driver SD into contact with a predetermined contact position on the workbench TB. In this case, the robot control section 47 adjusts the posture of the electric driver SD such that a rotation axis at the time when the shaft of the electric driver SD rotates is perpendicular to the surface of the workbench TB.

The robot control section 47 causes, according to control based on the second force sensor information acquired from the force-sensor-information acquiring section 45, the second end effector E2 to operate such that force having magnitude equivalent to the own weight of the electric driver SD is continuously applied perpendicularly to the predetermined contact position. Consequently, the distal end of the electric driver SD receives, according to the law of action and reaction, from the workbench TB, force (resistance) having magnitude same as the magnitude of force applied to the predetermined contact position by the distal end of the electric driver SD and in a direction opposite to the direction of the force applied to the predetermined contact position.

Subsequently, the robot control section 47 reduces the force of the second end effector E2 gripping the electric driver SD to thereby move the second end effector E2 to slip with respect to the electric driver SD while the second end effector E2 keeps gripping the electric driver SD (step S137). Consequently, the robot control section 47 changes at least one of the position and the posture of the second end effector E2 gripping the electric driver SD.

More specifically, the robot control section 47 reduces, while keeping the position and the posture of the electric driver SD, a gripping force of the second end effector E2 gripping the electric driver SD such that the resistance applied to the distal end of the electric driver SD from the workbench TB is larger than a static friction force between the second end effector E2, which is gripping the electric driver SD, and the electric driver SD. When the gripping force is reduced, the second end effector E2 can move to slide on the surface of the grip V2 of the electric driver SD while fixing the position and the posture of the electric driver SD.

The robot control section 47 moves, making use of this state, the second end effector E2 with respect to the electric driver SD to thereby change at least one of the position and the posture of the second end effector E2 gripping the electric driver SD. In this case, the robot control section 47 moves the second end effector E2 such that the second end effector E2 has a predetermined posture at predetermined height from the workbench TB. The predetermined height is height at which a relative position of the second end effector E2 with respect to the position of the electric driver SD is a position suitable for the predetermined work. The predetermined posture is a posture with which a relative posture of the second end effector E2 with respect to the posture of the electric driver SD is a posture suitable for the predetermined work. Consequently, the robot control section 47 can change the relative position and the relative posture of the second end effector E2 with respect to the electric driver SD to the position and the posture suitable for the predetermined work.

Subsequently, the robot control section 47 increases the gripping force of the second end effector E2 gripping the electric driver SD (step S138). More specifically, the robot control section 47 increases the gripping force of the second end effector E2 gripping the electric driver SD such that the resistance applied to the distal end of the electric driver SD from the workbench TB is smaller than the static friction force between the second end effector E2, which is gripping the electric driver SD, and the electric driver SD.

In this way, in the second work, the robot control section 47 performs the processing from steps S131 to S138 shown in FIG. 12 to thereby bring the electric driver SD into contact with the workbench TB and change at least one of the position and the posture of the second end effector E2 gripping the electric driver SD. Consequently, the robot control section 47 can change the relative position and the relative posture of the second end effector E2 with respect to the electric driver SD to the position and the posture suitable for the predetermined work.

Note that, in step S136, when some structure for fixing the distal end of the electric driver SD to the predetermined contact position, for example, when a recessed section is present in the predetermined contact position, the robot control section 47 may adjust the posture of the electric driver SD in a direction in which the rotation axis at the time when the shaft of the electric driver SD rotates has an angle different from the perpendicular with respect to the surface of the workbench TB.

In this case, the robot control section 47 brings a part of the second end effector E2 into contact with a part on the workbench TB side of the grip V2 of the electric driver SD and supports the electric driver SD not to fall. The robot control section 47 releases the gripping of the electric driver SD by the second end effector E2 while keeping the electric driver SD supported by the second end effector E2. In this way, the robot control section 47 can move the second end effector E2 to slide with respect to the grip V2 of the electric driver SD while keeping the electric driver SD supported by the second end effector E2.

In step S136, the robot control section 47 may bring the distal end of the electric driver SD into contact with a predetermined contact part of one of the first arm and the second arm. In this case, the robot control section 47 adjusts the posture of the electric driver SD and the posture of the contact part such that the rotation axis at the time when the shaft of the electric driver SD is perpendicular to the contact part. Consequently, the robot control section 47 can change the relative position and the relative posture of the second end effector E2 with respect to the electric driver SD to the position and the posture suitable for the predetermined work. The predetermined contact part is an example of a part of the robot.

In the second work, the robot control section 47 may grip the shaft V1 of the electric driver SD with the first end effector E1 and fix the position and the posture of the electric driver SD. That is, the robot control section 47 uses the first end effector E1 as an object with which the electric driver SD is brought into contact. In this case, the robot control section 47 releases the gripping of the electric driver SD by the second end effector E2 while keeping the electric driver SD gripped by the first end effector E1. The robot control section 47 can change the relative position and the relative posture of the second end effector E2 with respect to the electric driver SD to the position and the posture suitable for the predetermined work by moving the second end effector E2 with respect to the electric driver SD.

Before performing work, first, the robot control section 47 may change the relative position and the relative posture of the second end effector E2 with respect to the electric driver SD to the position and the posture suitable for the predetermined work according to any one of the methods explained above. Consequently, the robot control section 47 can start the work in a state in which the position and the posture of the second end effector E2 gripping the electric driver SD are initialized to the position and the posture suitable for the predetermined work.

The robot 20 may include, in the second end effector E2, a deviation detecting section that detects deviation of the position and the posture of the second end effector E2 with respect to the electric driver SD from the position and the posture suitable for the predetermined work. The deviation detecting section includes, for example, a contact sensor. When an integrated value of a movement amount of the second end effector E2 with respect to the electric driver SD detected by the contact sensor exceeds a predetermined threshold, the deviation detecting section outputs information indicating that the second end effector E2 deviates with respect to the electric driver SD to the control section 36 as information indicating a detection result.

In this case, the control section 36 includes a detection-result-information acquiring section that acquires information indicating the detection result of the deviation detecting section. When the information indicating the detection result is acquired from the detection-result-information acquiring section, the robot control section 47 changes the relative position and the relative posture of the second end effector E2 with respect to the electric driver SD to the position and the posture suitable for the predetermined work according to any one of the methods explained above. Consequently, every time the position and the posture of the second end effector E2 gripping the electric driver SD deviate, the robot control section 47 can correct the position and the posture of the second end effector E2 gripping the electric driver SD to the position and the posture suitable for the predetermined work.

Instead of the contact sensor, the deviation detecting section may detect deviation of the second end effector E2 with respect to the electric driver SD on the basis of picked-up images of the electric driver SD grasped by the second end effector E2 picked up by a part or all of the first image pickup section 21, the second image pickup section 22, the third image pickup section 23, and the fourth image pickup section 24.

In this case, the deviation detecting section acquires the picked-up images and detects deviation of the position and the posture of the second end effector E2 with respect to the electric driver SD from the position and the posture suitable for the predetermined work on the basis of the acquired picked-up images. When the deviation is detected, the deviation detecting section outputs information indicating that the second end effector E2 deviates with respect to the electric driver SD to the control section 36. Consequently, every time the position and the posture of the second end effector E2 gripping the electric driver SD deviate, the robot control section 47 can correct the position and the posture of the second end effector E2 gripping the electric driver SD to the position and the posture suitable for the predetermined work.

As explained above, the robot 20 in the modification of this embodiment reduces the gripping force of the second end effector E2 gripping the electric driver SD such that at least one of the position and the posture of the second end effector E2 gripping the electric driver SD. Consequently, the robot 20 can change at least one of the position and the posture of the second end effector E2 gripping the electric driver SD while the second end effector E2 keeps the position and the posture of the electric driver SD fixed.

The robot 20 brings the electric driver SD gripped by the second end effector E2 into contact with the predetermined contact part of one of the first arm and the second arm and changes at least one of the position and the posture of the second end effector E2 gripping the electric driver SD. Consequently, the robot 20 can perform highly accurate work with the electric driver SD gripped by the second end effector E2 using a part of the robot 20.

The robot 20 brings the electric driver SD gripped by the second end effector E2 into contact with a part of the workbench TB and changes at least one of the position and the posture of the second end effector E2 gripping the electric driver SD. Consequently, the robot 20 can perform highly accurate work with the electric driver SD gripped by the second end effector E2 using the workbench TB.

Before the second end effector E2 performs first work performed by the second end effector E2 with the electric driver SD, the robot 20 changes at least one of the position and the posture of the second end effector E2 gripping the electric driver SD. Consequently, the robot 20 can start work in a state in which the position and the posture of the second end effector E2 gripping the electric driver SD are initialized to a position and a posture suitable for the work.

When at least one of the position and the posture of the second end effector E2 gripping the electric driver SD deviates, the robot 20 changes at least one of the position and the posture of the second end effector E2 gripping the electric driver SD. Consequently, every time the position and the posture of the second end effector E2 gripping the electric driver SD deviate, the robot 20 can correct the position and the posture of the second end effector E2 gripping the electric driver SD to a position and a posture suitable for work.

The embodiment of the invention is explained in detail above with reference to the drawings. However, a specific configuration is not limited to the embodiment. The embodiment may be, for example, changed, substituted, and deleted without departing from the spirit of the invention.

A computer program for realizing the functions of any constituent sections in the device (e.g., the control device 30 of the robot 20) explained above may be recorded in a computer-readable recording medium. The computer program may be read by a computer system and executed. Note that the “computer system” includes an OS (Operating System) and hardware such as peripheral apparatuses. The “computer-readable recording medium” refers to a portable medium such as a flexible disk, a magneto-optical disk, a ROM, or a CD (Compact Disk)-ROM or a storage device such as a hard disk incorporated in the computer system. Further, the “computer-readable recording medium” includes a recording medium that retains a computer program for a fixed time such as a volatile memory (a RAM) inside the computer system functioning as a server or a client when the computer program is transmitted via a network such as the Internet or a communication line such as a telephone line.

The computer program may be transmitted from the computer system that stores the computer program in the storage device or the like to another computer system via a transmission medium or by a carrier wave in the transmission medium. The “transmission medium” for transmitting the computer program refers to a medium having a function of transmitting information like a network (a communication network) such as the Internet or a communication line (a communication wire) such as a telephone line.

The computer program may be a computer program for realizing a part of the functions explained above. Further, the computer program may be a computer program that can realize the functions explained above in combination with a computer program already recorded in the computer system, a so-called differential file (a differential program).

The entire disclosure of Japanese Patent Application No. 2015-084980, filed Apr. 17, 2015 is expressly incorporated by reference herein.

What is claimed is:

1. A robot comprising an arm and a hand,
the robot bringing a tool gripped by the hand into contact with an object and changing at least one of a position and a posture of the hand gripping the tool.

2. The robot according to claim 1, wherein the robot reduces a gripping force of the hand gripping the tool to make it possible to change at least one of the position and the posture.

3. The robot according to claim 1, wherein the robot changes at least one of the position and the posture after work performed by the hand with the tool.

4. The robot according to claim 1, wherein the object is a jig on which the tool is placed.

5. The robot according to claim 1, wherein the object is a part of a workbench.

6. The robot according to claim 1, wherein the object is a part of the robot.

7. The robot according to claim 1, wherein the robot changes at least one of the position and the posture before the hand performs first work with the tool.

8. The robot according to claim 1, wherein the robot changes at least one of the position and the posture when at least one of the position and the posture deviates.

9. The robot according to claim 1, wherein
a plurality of the arms are provided, and
the hand is provided in each of the arms.

10. The robot according to claim 1, wherein the hand is detachably attachable to the arm.

11. A control device that causes a robot including an arm and a hand to bring a tool gripped by the hand into contact with an object and change at least one of a position and a posture of the hand gripping the tool.
